(19) United States
(12) Patent Application Publication
(10) Pub. No.: US 2025/0173282 A1
(43) Pub. Date: May 29, 2025

(54) MEMORY DEVICE, OPERATING METHOD OF MEMORY DEVICE, AND OPERATING METHOD OF HOST DEVICE FOR MEMORY DEVICE

(71) Applicant: SAMSUNG ELECTRONICS CO., LTD., SUWON-SI (KR)

(72) Inventor: YONGMIN TAI, Suwon-si (KR)

(21) Appl. No.: 18/960,101

(22) Filed: Nov. 26, 2024

(30) Foreign Application Priority Data
Nov. 29, 2023 (KR) 10-2023-0169556

(51) Int. Cl. G06F 13/16; G06F 9/30; G06N 3/04

(52) U.S. Cl. CPC G06F 13/1668; G06F 9/3001; G06F 9/30047; G06N 3/04

(57) ABSTRACT

A memory device, an operating method of a memory device, and an operating method of a host device for a memory device are disclosed. The memory device includes a first accelerator disposed outside a memory and configured to perform a first operation based on a first instruction received from a host device, and at least one second accelerator disposed within the memory and configured to perform a second operation different from the first operation using a corresponding memory bank of the memory based on a second instruction received from the host device.

### CROSS-REFERENCE TO RELATED APPLICATIONS

This application is based on and claims priority under 35 USC § 119 of Korean Patent Application No. 10-2023-0169556, filed on Nov. 29, 2023, in the Korean Intellectual Property Office, the contents of which are incorporated by reference herein in their entirety.

### BACKGROUND

### 1. Field of the Invention

The following description relates to a memory device, an operating method of a memory device, and an operating method of a host device for a memory device.

### 2. Description of Related Art

In the realm of computing, the demand for high-performance systems has perpetually grown, fueled by applications ranging from artificial intelligence to scientific simulations. In some cases, methods have been developed that leverage proximity of computation and data storage and facilitate accelerated processing tasks. Advancements in hierarchical structures and operating methods have led to high-acceleration performance in memory devices. In some cases, a function of a memory device may be completely separated from a function of a processor performing an operation.

Accordingly, in such a system that requires an operation for a large volume of data, such as a neural network, big data, and Internet of Things (IoT), existing devices may frequently face challenges as a large volume of data is transmitted and received between a memory device and a processor. Therefore, there is a need in the art for systems and methods that can effectively distribute operations to enhance the utilization of hardware.

### SUMMARY

This summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

The present disclosure describes systems and methods for a memory device. Embodiments of the present disclosure include hierarchical structures and operating methods of processing in memory (PIM) and processing near memory (PNM) for high acceleration performance when both PIM and PNM operators (accelerators) exist in a large memory device. In some cases, a first accelerator and a second accelerator correspond to accelerators having different layers included in a memory device for accelerating a layer-wise operation of a neural network model.

In one general aspect, a memory device includes a first accelerator disposed outside a memory and configured to perform a first operation based on a first instruction received from a host device, and at least one second accelerator disposed within the memory and configured to perform a second operation different from the first operation using a corresponding memory bank of the memory based on a second instruction received from the host device.

The first accelerator includes a plurality of acceleration engines configured to accelerate at least one operation performed by the memory device and each of the plurality of acceleration engines includes a control unit configured to generate instructions and a processing unit configured to process the generated instructions.

The control unit includes a decoder configured to decode instructions from the host device, wherein the first operation and second operation are performed based on the decoding, a scheduler configured to select an accelerator from a set including a first accelerator controller corresponding to the first accelerator, a second accelerator controller corresponding to the at least one second accelerator, and a sync controller based on at least one of a specific bit of the at least one instruction and a sync bit, the first accelerator controller configured to control the first accelerator to perform the first instruction when the first accelerator is selected, the second accelerator controller configured to control the second accelerators to perform the second instructions when the second accelerators are selected, and the sync controller is selected based on a sync bit indicating whether consecutive instructions are performed by different accelerators.

The sync controller is configured to store an operation result of the at least one second accelerator such that the first accelerator occupies the memory and limit a pre-fetching operation of the at least one second accelerators when a previous operation instruction of the consecutive operation instructions is performed by at least one of the second accelerators and the designated accelerator is the first accelerator.

The sync controller is configured to record an output of the first accelerator and provide the output to the at least one second accelerator occupies the memories when a previous operation instruction of the consecutive operation instructions is performed by the first accelerator and the designated accelerator is at least one of the second accelerators.

Each of the plurality of acceleration engines further includes at least one of a data buffer configured to store an operation result, wherein the processing unit is configured to perform operations based on the stored operation result, and the processing unit configured to perform an operation by loading the data from the data buffer and store a result of performing the operation in a high-speed communication buffer or the data buffer.

The first accelerator includes a processing near memory (PNM) device, and the at least one second accelerator includes a processing in memory (PIM) device.

The first operation includes a non-linear operation or a multiplication operation between matrices, and the second operation includes a linear operation or a multiplication operation between a matrix and a vector.

In another general aspect, a method of operating a memory device includes receiving an operation instruction for a memory device from a host device, decoding and storing the operation instruction in an instruction buffer, selecting a target accelerator from a set including a first accelerator disposed outside a memory of the memory device and at least one second accelerator of the memory device disposed within the memory based on the operation instruction, and performing the operation instruction using the target accelerator.

The controlling of the at least one further comprising decoding the operation instruction, wherein the target accelerator is selected based on the decoded operation instruction.

The controlling further comprises selecting the target accelerator comprises selecting from among a plurality of second accelerators corresponding to a plurality of bank groups of the memory, respectively.

In another general aspect, a method of operating a host device includes generating an operation instruction for a memory device, determining that a target accelerator for processing the operation instruction is located at a different layer of the memory device than a previous accelerator used for processing a previous operation instruction, adjusting the operation instruction for the different layer based on the determination, and transmitting the adjusted operation instruction to the memory device.

The determining includes identifying instruction information for the operation instruction including at least one of a size and a dimension of input data, an operation type of a layer of a neural network model, and batch processing information, wherein the determination is based on the instruction information.

The adjusting of the operation instruction includes adjusting a bit value of the operation instruction for controlling an input and an output between different accelerators included in the operation instruction to be suitable to the layer of the current accelerator.

The method further comprising recording an output of the previous accelerator in a memory of the target accelerator.

The method further includes receiving input data and operation block information, wherein the operation instruction is generated based on the input data and the operation block information.

The host device includes at least one of a central processing unit (CPU), a graphics processing unit (GPU), and a processor for a data center.

In another aspect, a method comprises receiving, at a memory device, an operation instruction from a host device, determining a complexity of the operation instruction, selecting a target accelerator based on the complexity of the operation instruction, wherein the target accelerator is selected from a set including a first accelerator disposed outside a memory of the memory device and at least one second accelerator disposed within the memory device, and processing the operation instruction using the target accelerator.

The complexity is determined based on whether an operation of the operation instruction is linear. The complexity is determined based on whether an operation of the operation instruction includes multiplication of two matrices.

Other features and aspects will be apparent from the following detailed description, the drawings, and the claims.

### BRIEF DESCRIPTION OF THE DRAWINGS

FIG. 1 illustrates an example of a memory device according to an embodiment.

FIG. 2 illustrates an example of a configuration and an operation of a memory device including a first accelerator and second accelerators according to an embodiment.

FIG. 3 illustrates an example of an internal configuration of a first accelerator and connections between second accelerators and a memory according to an embodiment.

FIG. 4 illustrates an example of a method to process an instruction transmitted by a host device according to an embodiment.

FIG. 5 is a flowchart illustrating an operating method of a memory device according to an embodiment.

FIG. 6 is a flowchart illustrating an operating method of a host device according to an embodiment.

FIG. 7 illustrates a block diagram for determining an accelerator for each operation according to an embodiment.

FIG. 8 illustrates a process for generating an instruction for an accelerator to perform a layer-wise operation of a neural network model according to an embodiment.

FIG. 9 illustrates an example in which instructions are stored in a buffer of a memory device according to an embodiment.

FIG. 10 illustrates an example in which an instruction group based on an accelerator is stored in a buffer of a memory device according to an embodiment.

FIG. 11 illustrates an example of a method for determining an accelerator that performs a layer-wise operation of a neural network model according to an embodiment.

FIGS. 12-14 illustrate a flowchart for an operating method of a memory system according to an embodiment

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The present disclosure describes systems and methods for a memory device. Embodiments of the present disclosure include hierarchical structures and operating methods of processing in memory (PIM) and processing near memory (PNM) for high acceleration performance when both PIM and PNM operators (accelerators) exist in a large memory device. In some cases, a first accelerator and a second accelerator correspond to accelerators having different layers included in a memory device for accelerating a layer-wise operation of a neural network model.

Existing systems face numerous challenges for the realization of high-acceleration performance in large memory devices despite the advantages provided by PIM and PNM architectures. In scenarios where both PIM and PNM operators coexist within a single memory device, the complexity escalates, demanding sophisticated management strategies to ensure seamless operation and optimal utilization of resources. Such systems face challenges including high data movement between devices, inefficient distribution of computational tasks across diverse processing elements, low synchronization of operations within hierarchical structures, and potential conflicts arising from concurrent access to shared resources.

Accordingly, embodiments of the present disclosure include hierarchical structures and operating methods for high acceleration performance. In some cases, the memory device of the present disclosure integrates a memory function with a function of a processor performing an operation. Additionally, embodiments include systems and methods for performing an operation in a memory device since data transmission between a host device and a memory device may occupy most latency when executing many application programs requiring large memory usage.

Embodiments of the present disclosure include systems that may effectively distribute operations to each accelerator in a host device when performing an operation by offloading the operation to PIM or PNM. For example, the host device may instruct the PIM or PNM to perform an operation in a layer of a neural network model. According to an embodiment, the PIM may be used to accelerate a linear operation having low complexity in the model. In some cases, the PNM may perform a non-linear operation having high complexity in the model.

In some cases, the PIM may be used for a linear operation since the operator is attached to a memory bank array in a memory die. Particularly, the PIM may be for acceleration of a matrix and a vector operation (e.g., referring to matrix multiplications). Additionally, the PNM is disposed outside of the memory die. In some cases, a bandwidth of the PNM transmitting data from the memory to the PNM may be lower than that of the PIM. Accordingly, the PNM may take a longer time to load a large volume of input matrices or weight matrices than the PIM.

Accordingly, by including both PIM and PNM operators in a large memory device, embodiments of the present disclosure are able to perform a linear operation by the PIM and a non-linear operation by the PNM that the PIM is not able to support due to the DRAM process or area restriction. Additionally, by effectively distributing operations to each accelerator in a host device when performing an offloading operation for PIM or PNM operators, embodiments are able to increase hardware utilization and minimize data transmission between the host device and the memory device.

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Embodiments of the present disclosure may be applied to a neural network, a processor, a smartphone, a mobile device, and the like performing an artificial intelligence (AI) operation and/or high performance computing (HPC) processing including a method of processing in memory (PIM) and processing near memory (PNM) to achieve high acceleration performance.

Hereinafter, the embodiments will be described in detail with reference to the accompanying drawings. When describing the embodiments with reference to the accompanying drawings, like reference numerals refer to like elements and a repeated description related thereto will be omitted.

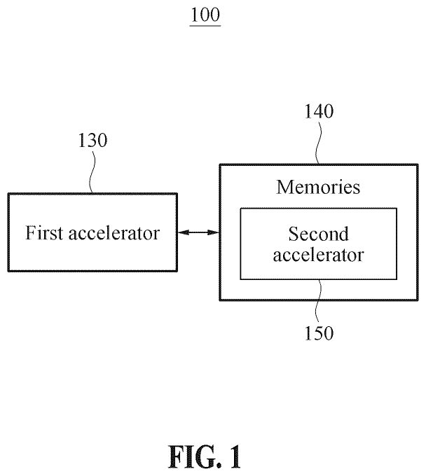

FIG. 1 illustrates an example of a memory device according to an embodiment. Referring to FIG. 1, a memory device 100 in an embodiment may include a first accelerator 130 and a second accelerator 150 included in memory 140. In some cases, memory device 100 may include a plurality of memory units, such as memory 140. In some cases, a plurality of second accelerators may be included in each memory (such as memory 140) of the plurality of memory units.

Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor to perform various functions described herein.

In some cases, memory includes a basic input/output system (BIOS) that controls basic hardware or software operations, such as an interaction with peripheral components or devices. In some cases, memory includes a memory controller that operates memory cells of memory. For example, the memory controller may include a row decoder, column decoder, or both. In some cases, memory cells within memory store information in the form of a logical state.

An accelerator refers to a hardware component or subsystem designed to enhance the performance and functionality of memory systems within computing devices. In some cases, the accelerator is used to optimize memory operations, such as data retrieval, storage, and manipulation, by employing dedicated processing resources and algorithms tailored to memory-intensive tasks. The accelerator works in tandem with the underlying memory architecture, leveraging techniques such as parallel processing, data prefetching, compression, encryption, or advanced caching mechanisms to expedite data access and processing. By offloading specific memory-related computations from the main processor, the accelerator significantly increases overall system performance, reduces latency, and conserves power, thereby improving the efficiency and responsiveness of computing systems for various applications and workloads.

The memory device 100 may communicate with a host device via a high-speed communication interface and may have a structure in which two types of accelerators (e.g., a processing near memory (PNM) device and a processing in memory (PIM) device) are hierarchically configured. The high-speed communication interface may include, for example, a peripheral component interconnect express (PCIe) interface or a computer eXpress link (CXL) interface. However, the example is not limited thereto and any other high-speed communication interface may be included.

A Processing Near Memory (PNM) device represents an approach to computing architecture, where processing elements are situated in close proximity to memory units. The design facilitates accelerated data processing by minimizing data transfer distances, thus reducing latency and energy consumption. PNM devices integrate specialized processing units within or adjacent to memory modules, enabling efficient parallel processing of data directly at the memory location. Accordingly, enhanced computational performance is achieved, particularly for tasks involving large datasets or frequent memory access. The PNM device overcomes bottlenecks associated with separate processing and memory units.

A Processing In Memory (PIM) device is configured to embed processing capabilities directly within memory components. In some cases, PIM devices integrate processing units within memory arrays, enabling simultaneous data processing and storage operations. The integration significantly reduces data movement and alleviates memory bandwidth limitations, resulting in improvements in performance, energy efficiency, and scalability. PIM devices may be used to handle data-intensive workloads, such as machine learning algorithms, database operations, and scientific simulations, by leveraging parallel processing capabilities within the memory substrate. The PIM device enables enhancement of computational efficiency and provides for advancements in various domains.

The memory device 100 may be a large-capacity memory device and may provide high acceleration performance using both a PIM device and a PNM device. The memory device 100 may be, for example, a CXL memory device communicating via a CXL interface. However, the example embodiments are not limited thereto.

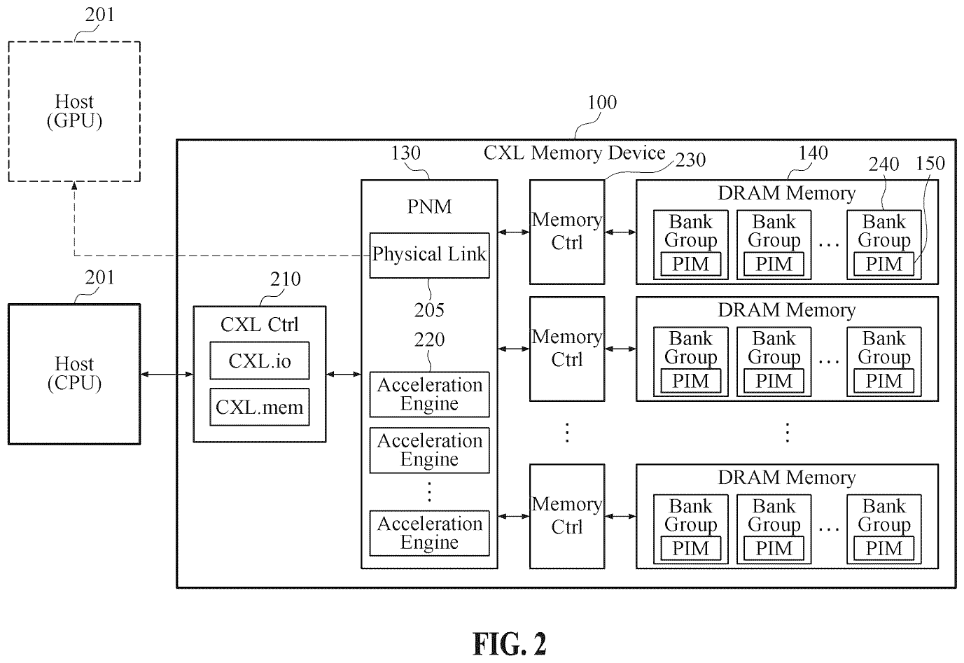

The high-speed interface may receive an operation instruction transmitted by a host device (e.g., a host device 201 described with reference to FIG. 2). The high-speed communication interface may be a CXL interface. The CXL interface may correspond to a cache coherence interconnection standard among a processor, memory expansion, and an accelerator. The CXL interface may correspond to an interface that reduces overhead and a wait time of a host device and the memory device 100 in a heterogeneous computing environment in which the host device and the memory device 100 operate together and enables sharing of a memory of the host device and a space of the memory device 100. In some cases, the CXL interface may allow a host device, a system-on-chip (SoC), a graphics processing unit (GPU) performing a complex operation, and/or an acceleration module, such as a field-programmable gate array (FPGA), to directly communicate and share a memory.

The first accelerator 130 may be disposed outside the memories 140 (e.g., first accelerator 130 may be disposed outside of a die of the memories 140) and may decode an operation instruction received from the host device via the high-speed communication interface. The first accelerator 130 may transmit a decoded instruction to a controller of a corresponding accelerator (e.g., the first accelerator 130 or the second accelerator 150) or may perform a first operation based on the decoded instruction. For example, the first operation may include a non-linear operation including a multiplication operation between matrices. However, example embodiments are not limited thereto and the first operation may include different operations.

The first accelerator 130 may include, for example, a PNM device. The first accelerator 130 may include acceleration engines for accelerating at least one operation performed by the memory device 100.

Each of the second accelerators (e.g., second accelerator 150) may be disposed in the memory 140, more specifically, a die of the memory 140, and may respectively correspond to memory banks of the memory 140. The second accelerator 150 may perform a second operation distinguished from the first operation on each of the memory banks of the memory 140 in response to an instruction decoded by the first accelerator 130. For example, the second operation may include a linear operation including a multiplication operation between a matrix and a vector. However, example embodiments are not limited thereto.

Each of the second accelerators (e.g., second accelerator 150) may correspond to a semiconductor integrating a processor (e.g., an internal processor) with a memory in a single chip. Each of the second accelerators (e.g., second accelerator 150) may include, for example, a PIM device. In some examples, in the second accelerator 150, a unique instruction of the second accelerator may be performed that corresponds to (i.e., to perform) an operation. The unique instruction of the second accelerator may be referred to as a “memory command” or a “PIM instruction”. The memory command may be accessed through an external host device 201.

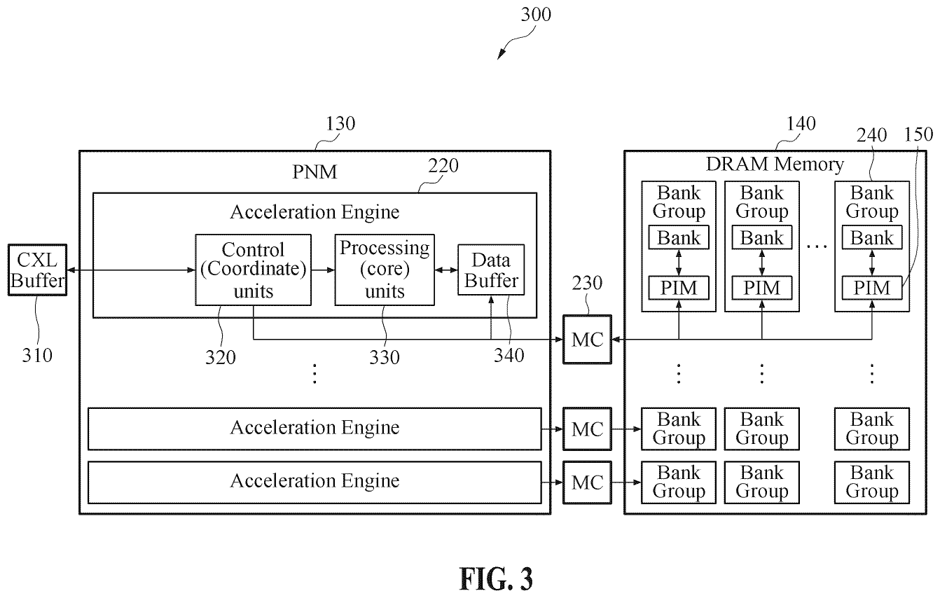

In some cases, the first accelerator 130 and the second accelerator 150 may correspond to accelerators having different layers included in a memory device. A configuration and operations of the first accelerator 130 and the second accelerator 150 are further described with reference to FIGS. 2 and 3.

FIG. 2 illustrates an example of a configuration and an operation of a memory device including a first accelerator and a plurality of second accelerators (such as second accelerator 150 described with reference to FIG. 1) according to an embodiment. Referring to FIG. 2, the memory device 100 may include a CXL controller 210, the first accelerator 130, memory controller 230 of a plurality of memory controllers, and the second accelerator 150 of the plurality of second accelerators respectively included in a memory 140 of the plurality of memories.

The CXL controller 210 may provide for the host device 201 to directly communicate with the first accelerator 130 in the memory device 100 via a CXL interface and may provide for the host device 201 to share the memory 140 of the plurality of memories. The CXL interface may include, for example, CXL.io, CXL.cache, and/or CXL.mem, which are subprotocols. The CXL.io protocol may be a PCIe transaction layer and may be used for device search, interrupt management, access provision by a register, initialization processing, and/or signal error processing. The CXL.cache protocol may be used by an accelerator (e.g., the first accelerator or the second accelerator) to access a memory of the host device 201. The CXL.mem protocol may be used by the host device 201 to access the memory 140 of an accelerator (e.g., the second accelerator). The CXL controller 210 may include a buffer area for the CXL.io protocol and a buffer area for the CXL.mem protocol.

The host device 201 may receive information including input data and an operation in the unit of operation block of an application program through an application program interface (API).

The host device 201 may determine one of the first accelerator 130 and the second accelerator 150 to perform an operation depending on a type of the input data and may transmit, to the memory device 100, an operation instruction with respect to the determined accelerator. Additionally, the host device 201 may adjust the operation instruction based on a layer of the determined accelerator (e.g., a current accelerator) and may transmit the adjusted operation instruction to the memory device.

In some cases, the operation instruction includes information about the layer of the accelerator (e.g., the first accelerator 130 of an upper layer or the second accelerators 150 of a lower layer) related to the instruction. Additionally, the operation instruction may include a sync bit for the memory usage of the displayed accelerator.

For example, the sync bit may be set to “1” when an operation for a previous layer and an operation for a current layer are performed by accelerators of different layers. Accordingly, a synchronization operation needs to be performed to provide output values of each accelerator as input values to accelerators of different layers. In some cases, when the operation for the previous layer and the operation for the current layer are performed by the accelerator of the same layer, the synchronization operation may not need to be performed, and thus, the sync bit may be set to “0”.

The host device 201 may determine one (a “target accelerator”) of the first accelerator 130 and the second accelerator 150 to perform an operation depending on the size and dimension of the input data, a type of an operation performed by each layer of the neural network model, and batch processing of a layer performing the operation.

For example, the host device 201 may enhance hardware utilization by effectively distributing various operations to the first accelerator 130 or the plurality of second accelerators using software while minimizing transmission between the host device 201 and the memory device 100 when various operations need to be performed by being offloaded from various portions of an application program executed by the host device 201 to the first accelerator 130 or the second accelerator 150.

The host device 201 may be, for example, a central processing unit (CPU), a GPU, a neural processing unit (NPU), an FPGA, a processor, a microprocessor, a processor for a data center, or an application processor (AP). A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

However, the example embodiments are not limited thereto. In some cases, the host device 201 may be implemented as an SoC. A System-on-Chip (SoC) refers to a comprehensive integrated circuit (IC) design that consolidates multiple electronic components and functionalities onto a single semiconductor chip. The SoC encompasses various hardware elements essential for the operation of a computing device or electronic system, including central processing units (CPUs), memory units, input/output (I/O) interfaces, peripheral controllers, and often specialized accelerators or coprocessors.

In some cases, the host device 201 may be, for example, a mobile system, such as a mobile communication terminal (a mobile phone), a smartphone, a tablet personal computer (PC), a wearable device, a healthcare device, or an Internet of Things (IoT) device, or an automotive device, such as a PC, a laptop, a computer, a server, a media player, or a navigator. Hereinafter, for ease of description, a description is provided based on a case in which a CPU is the host device 201. However, the example is not limited thereto and the same description may be applied to a case in which any other device is the host device 201.

Additionally, the host device 201 may include a separate memory controller and/or a communication device and may perform the transmission and reception of a signal between the host device 201 and external devices according to various communication protocols. The communication device may be a device for performing wired or wireless connection and may include, for example, an antenna, a transceiver, and/or a modem. The host device 201 may also perform an ethernet network or wireless communication via the communication device.

The host device 201 may be connected to at least one of the CXL controller 210, the first accelerator 130, the memory controller 230, second accelerator 150 of the plurality of second accelerators in the each memory 140 via a high-speed communication interface (e.g., a CXL interface) and may control the overall operation of the memory device 100.

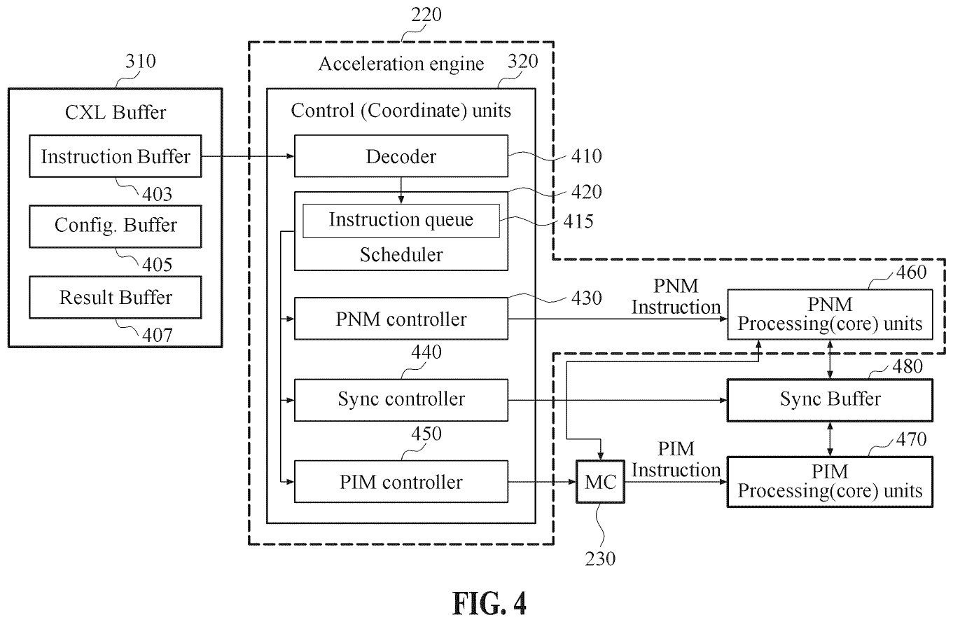

The first accelerator 130 may be disposed outside the memory 140, may decode an operation instruction received via the high-speed communication interface, may transmit the decoded instruction to a controller of a corresponding accelerator (e.g., the first accelerator 130 or the second accelerator 150), or may perform a first operation in response to the decoded instruction. The first accelerator 130 may include a plurality of acceleration engines for accelerating at least one operation performed by the memory device 100. A configuration and operations of an acceleration engine 220 are described with reference to FIGS. 3 and 4.

The first accelerator 130 may be connected to the host device 201 via a CXL.cache protocol and a CXL.mem protocol of the CXL interface included in the CXL controller 210. The first accelerator 130 may transmit or receive an instruction (e.g., A.CMD) and operation data (e.g., A.cache/mem) to or from the host device 201 and may transmit or receive data by selecting one from the CXL.cache protocol and the CXL.mem protocol depending on an entity transmitting the data.

Each memory controller 230 of the plurality of memory controllers may, for example, include a memory interface and may control a memory operation, such as write and read operations, by providing various signals to the second accelerator 150 of the plurality of second accelerators via the memory interface. Each memory controller 230 may access data of the second accelerator 150 stored in the memory 140 by providing a command (CMD) and an address (ADD) to the second accelerator 150. The CMD may include a write (WR) command requesting data recording and a read (RD) command requesting data reading.

Each memory controller 230 of the plurality of memory controllers may access second accelerator 150 of the plurality of second accelerators in response to the request by the host device 201. The memory interface included in each memory controller 230 may provide an interface with the second accelerators. Each of the memory controller 230 may communicate with the host device 201 using various protocols. For example, the memory controller 230 may communicate with the host device 201 using an interface protocol, such as PCIe, advanced technology attachment (ATA), serial ATA (SATA), parallel ATA (PATA), or serial attached small computer system interface (SAS). In addition, various interface protocols, such as universal serial bus (USB), multi-media card (MMC), enhanced small disk interface (ESDI), or integrated drive electronics (IDE) may be used for communication between the host device 201 and the memory controller 230.

Each memory controller 230 may be a memory controller for a CXL memory device and may be connected to the memory 140 to control an operation with respect to the memory 140. Each of the memory controller 230 may be connected to a dynamic random access memory (DRAM) including a plurality of memory banks and the second accelerators. For example, each of the memory controller 230 may perform an access operation, such as reading or deleting data stored in each of the memory 140 or writing data in each of the memory 140. The plurality of memory controllers may maintain data consistency between the plurality of memories and the memory of the host device 201 with a significantly high bandwidth through the CXL interface with the host device 201. Each memory controller 230 may respectively match the acceleration engine 220 of the plurality of acceleration engines included in the first accelerator 130. Acceleration engine 220 is further described with reference to FIGS. 3 and 4.

In some examples, the memory 140 may be, for example, DRAM, such as random access memory (RAM), data rate synchronous DRAM (DDR SDRAM), low power double data rate (LPDDR) SDRAM, graphics double data rate (GDDR) SDRAM, and rambus DRAM (RDRAM). However, the example is not limited thereto. The memory 140 may be implemented by non-volatile memory, such as flash memory, magnetic RAM (MRAM), ferroelectric RAM (FeRAM), phase change RAM (PRAM), and resistive RAM (ReRAM). Hereinafter, for ease of description, a description is provided based on an example in which the memories 140 are RAM. However, embodiments are not limited thereto.

The memory banks of the memory 140 may refer to a plurality of banks (e.g., BANK 1 to BANK N). Each of the banks BANK 1 to BANK N may include a plurality of memory cells or a cell array comprising a plurality of memory cells. In some cases, the bank may be variously defined. For example, the bank may be defined as a configuration including memory cells or the bank may also be defined as a configuration including memory cells and at least one peripheral circuit. Hereinafter, for ease of description, the term “memory bank” may be simply referred to as a “bank”.

Each second accelerator 150 of the plurality of second accelerators may respectively correspond to a memory bank 240 (or a bank group) of the memory 140, and may perform a second operation distinguished from a first operation on each memory bank 240 of the memory 140 in response to an instruction decoded by the first accelerator 130. In addition, the second accelerator 150 may correspond to one semiconductor chip or may be a configuration corresponding to one channel in the memory device 100 including multiple channels having an independent interface. Alternatively, the second accelerator 150 may be a configuration corresponding to a memory module including multiple memory chips.

Various types of computational processing operations may be performed by the first accelerator 130 and/or the second accelerators 150. For example, the first accelerator 130 and/or the second accelerator 150 may perform at least a portion of operations of a neural network model related to AI (e.g., machine learning). For example, the host device 201 may control the second accelerator 150 via the memory controller 230 such that the second accelerator 150 may perform at least a portion of operations of a neural network model.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

A Neural Network model or an Artificial neural network model (ANN) includes numerous parameters, including weights and biases associated with each neuron in the network, that control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

The memory bank 240 or memory cells in the memory bank 240 in which data access is performed may be selected by an address ADD transmitted from the memory controller 230.

The memory controller 230 may transmit one or more instructions (e.g., Inst) to perform an operation processing using data to each second accelerator 150. The second accelerator 150 may receive and store the instructions (e.g., Inst) therein (e.g., an instruction memory). For example, each second accelerator 150 may include one or more processing elements and an instruction memory configured to store instructions. In some cases, the processing element of the second accelerator 150 may perform an operation corresponding to the instruction (e.g., Inst) read from the instruction memory when receiving a command CMD or an address ADD instructing the operation processing from the memory controller 230.

Meanwhile, the memory controller 230 may perform a control operation such that each second accelerator 150 may perform operation processing using commands related to a normal memory operation. For example, a bit value of an address ADD provided by the memory controller 230 may be classified into multiple ranges. For example, the address ADD may instruct a memory operation or operation processing based on the bit value.

The second accelerator 150 may selectively perform the memory operation or the operation processing operation in response to the command CMD or the address ADD from the memory controller 230. For example, each second accelerator 150 may perform an operation in response to a data write or read (WR or RD) command from the memory controller 230.

The memory controller 230 may transmit the address ADD, in which instructions instructing the memory operation are stored, together with the data write WR or read RD command to the second accelerator 150. When a value of the address ADD instructs the memory operation, the second accelerator 150 may perform the memory operation of reading data or writing data in a position instructed by the address ADD of the memory bank 240 depending on the value of the decoded address ADD. In some cases, the second accelerator 150 may perform the operation processing depending on a decoding result with respect to the command CMD or the address ADD when the value of the address ADD instructs the operation processing operation.

For example, processing elements of the second accelerator 150 may perform operation processing using data provided by the memory controller 230 or may perform operation processing using data read from the memory bank 240 of the plurality of memory banks.

A command transmitted by the host device 201 may be decoded by hardware (e.g., a decoder 410 of FIG. 4) in the memory device 100 and may be transmitted as a command to an accelerator (e.g., such that it is appropriate to each accelerator). Accordingly, the memory device 100 may transmit a result, which has a small size and is computed in the memory device 100, to the host device 201 to overcome a low bandwidth between the host device 201 and the memory device 100.

According to an embodiment, the first accelerator 130 (e.g., a PNM device) of an upper layer corresponding to the entirety of the memory device 100 and the second accelerator 150 (e.g., PIM devices) of a lower layer corresponding to the memory bank 240 in each memory 140 of the plurality of memories may coexist and thereby may mutually complement an operation. In this case, the “upper layer” and the “lower layer” may be distinguished based on a position of a corresponding accelerator with respect to the memory controller and a type of an operation to be processed. For example, the upper layer may refer to a layer higher than the memory controller and a lower layer may refer to a layer lower than the memory controller.

The first accelerator 130 may, for example, exist outside of a die of the DRAM memory, and the second accelerators 150 may, for example, exist inside the die of the DRAM memory. For example, the first accelerator 130 may process a complex operation, such as a matrix linear operation between matrices and a non-linear operation. The second accelerators 150 may process a relatively simple operation, such as a linear operation between a matrix and a vector.

The second accelerator (e.g., a PIM device) of the lower layer configured in each memory bank 240 of the plurality of memory banks may process only a specific operation on some layers of a neural network model with limited operation processing capability. However, the second accelerator may provide a high acceleration effect with a significantly high bandwidth. In addition, the first accelerator (e.g., a PNM device) may correspond to an accelerator of the upper layer that is higher than the memory controller 230. The first accelerator (e.g., a PNM device) may have low acceleration performance due to a lower bandwidth than the second accelerator (e.g., a PIM device), however, the first accelerator may process most operations including a non-linear operation that the second accelerator may not process. As the memory device 100 uses both accelerators, the host device 201 may not need to frequently move a large volume of data from the memory 140 and may process an operation end-to-end as possible. In addition, the memory device 100 may accelerate a neural network model (e.g., a large language model (LLM)) by the minimum data movement from the memory 140.

The memory device 100 may efficiently provide an operation result of an accelerator of each layer as an input to an accelerator of the other layer by controlling an accelerator of one layer to occupy and use the memory 140.

According to an embodiment, the memory device 100 may support not only the connection between the host device 201 and the CXL interface but also data transmission with the host device 201 using the connection via a physical external cable. For example, when the host device 201 is configured as a GPU (as shown using a dotted line of FIG. 2), a physical interface may be provided wherein the physical interface may connect the memory device 100 to the cable connection (e.g., NVLink of NVIDIA®) physically connecting devices between GPUs. The physical interface may be provided through a physical link module 205 included in the first accelerator 130.

The memory device 100 using the CXL interface may hierarchically process a simple operation and a complex operation through multiple hierarchical accelerators (e.g., the first accelerator 130 and the second accelerator 150) and may effectively accelerate an operation without a bottleneck event occurring in the memory 140 while minimizing data transmission between the host device and the memory. The memory device 100 may support data transmission with the host device 201 through the CXL interface as well as through the physical external cable connection by the physical link module 205.

FIG. 3 illustrates an example of an internal configuration of a first accelerator and connections between the second accelerators and a memory according to an embodiment. FIG. 3illustrates a case in which the first accelerator 130 (e.g., a PNM device) and the second accelerator 150 (e.g., plurality of PIM devices) corresponding to the memory bank 240 (e.g., bank groups) of the memory 140 are interconnected through the memory controller 230.

The first accelerator 130 (e.g., a PNM device) of an upper layer may include acceleration engines 220 accelerating one or more operations. Each acceleration engine 220 of the plurality of acceleration engines may include a control unit 320, a processing unit 330, and a data buffer 340. In this case, the processing unit 330 may operate as a core for an operation and the control unit 320 may operate as a coordinator assisting the processing unit 330.

A high-speed communication buffer 310 (e.g., a CXL buffer) may be disposed outside of the first accelerator 130 (e.g., a PNM device) and may store instructions including an operation instruction transmitted from the host device 201 to the memory device 100. The high-speed communication buffer 310 (e.g., a CXL buffer) may not be provided for each of the number of acceleration engines 220. The high-speed communication buffer 310 (e.g., a CXL buffer) may be shared by the acceleration engines 220.

The operation instruction may include an instruction for the first accelerator 130 and/or an instruction for the second accelerator 150. The high-speed communication buffer 310 may be mapped with a high-speed communication interface (e.g., the CXL interface).

The control unit 320 may generate at least one of a first instruction for the first accelerator 130 or a second instruction for the second accelerators 150 by decoding an operation instruction. In addition, the control unit 320 may control data movement in the first accelerator 130 and execution of the processing unit 330. The configuration and operation of the high-speed communication buffer 310 and the control unit 320 are further described with reference to FIG. 4.

The processing unit 330 may load data from the data buffer 340 and may perform an operation. The processing unit 330 may store a result of performing an operation in the high-speed communication buffer 310 outside of the first accelerator 130 (e.g., a PNM device) and/or the data buffer 340 in the first accelerator 130 (e.g., a PNM device).

The data buffer 340 may store data loaded from the memory 140 or may store an operation result of the processing unit 330. The data buffer 340 may include a sync buffer (sync buffer 480 described with reference to FIG. 4). In this case, the data buffer 340 and the sync buffer may correspond to buffers sharing a memory space.

FIG. 4 illustrates an example of a method of the memory device 100 to process an instruction transmitted by the host device 201 according to an embodiment. FIG. 4illustrates configurations and operations of the control unit 320 of the acceleration engine 220 and the high-speed communication buffer 310 (e.g., the CXL buffer) of the first accelerator 130.

The control unit 320 of the acceleration engine 220 may include, for example, a decoder 410, an instruction queue 415, a scheduler 420, a first accelerator controller 430 (e.g., a PNM controller), a sync controller 440, a second accelerator controller 450 (e.g., a PIM controller), and a processing unit 460 of the first accelerator.

The decoder 410 may generate at least one instruction including a first instruction for the first accelerator and a plurality of second instructions for the second accelerators by decoding an operation instruction stored in an instruction buffer 403 of the CXL buffer 310. The operation instruction stored in the instruction buffer 403 may be received from the host device through the CXL interface. The CXL buffer 310 may further include a configuration buffer 405 (e.g., a config. buffer) and a result buffer 407 other than the instruction buffer 403.

In some cases, the configuration buffer 405 may correspond to a buffer for setting a register for substantially driving the first accelerator controller 430 (e.g., a PNM controller). For example, when a start register in the configuration buffer 405 is set after the host device 201 records an instruction in the instruction buffer, the first accelerator controller 430 (e.g., a PNM controller) may start an operation by reading the instruction written in the instruction buffer. The configuration buffer 405 may include, for example, a start register, a reset register, a done register, and/or information about an error bit. In addition, the result buffer 407 may correspond to a space in which an operation result of the first accelerator controller 430 (e.g., a PNM controller) is stored. When an operation of an instruction set is terminated, the result buffer 407 may correspond to a memory space storing data for the host device 201 to read an operation result of the instruction set.

The instruction queue 415 may sequentially store at least one instruction generated by the decoder 410.

The scheduler 420 may designate an accelerator corresponding to one of the first accelerator controller 430, the sync controller 440, and the second accelerator controller 450 based on at least one of a sync bit and a specific bit of at least one instruction stored in the instruction queue 415. In some cases, the specific bit refers to a value (e.g., “0” or “1”) indicating whether the instruction is for a first operation of the first accelerator (e.g., a PNM device) or a second operation of the second accelerator. Additionally, the sync bit may be set to “1” when an operation for a previous layer and an operation for a current layer among consecutive operation instructions are performed by accelerators of different layers. Thus, a synchronization operation needs to be performed to provide output values of each accelerator as input values to accelerators of different layers.

In some cases, the scheduler 420 may select a controller for a corresponding instruction from the first accelerator controller 430, the sync controller 440, and the second accelerator controller 450 by identifying the specific bit and the sync bit of the instruction and may transmit an instruction to a corresponding accelerator through the selected controller.

For example, when the specific bit of the instruction is set to be“ 1” and the sync bit is set to be “0”, the scheduler 420 may select the first accelerator controller 430 and may transmit the first instruction to the processing unit 460 of the first accelerator. In some examples, when the specific bit of the instruction is set to be “0” and the sync bit is set to be “0”, the scheduler 420 may select the second accelerator controller 450 and may transmit the second instruction to a processing unit 470 of the second accelerator. In this case, the processing unit 460 of the first accelerator may correspond to the processing unit 330 as described with reference to FIG. 3.

In addition, when the sync bit is set to be “1” regardless of the specific bit of the instruction, the scheduler 420 may select the sync controller 440 and may store, in the sync buffer 480, an operation result of the processing unit 460 of the first accelerator and/or an operation result of the processing unit 470 of the second accelerator. In this case, the processing unit 470 of the second accelerator may be included in the second accelerators 150.

When the first accelerator is designated by the scheduler 420, the first accelerator controller 430 may control the first accelerator, more specifically, the processing unit 460 of the first accelerator to perform the first instruction.

The sync controller 440 may be driven when, for example, the sync bit included in the instruction decoded by the decoder 410 is set to a value of “1”.

When consecutive operation instructions are performed by different accelerators, the sync controller 440 may restrict the use of an accelerator that is not designated to a memory for use of the accelerator designated by the scheduler 420. For example, among consecutive operation instructions, when a previous operation instruction is performed by at least one of the second accelerators and an accelerator designated by the scheduler 420 is the first accelerator, the sync controller 440 may store or copy an operation result of the at least one second accelerator in the sync buffer 480 and may allow the first accelerator to use the operation result of the second accelerator. In addition, the sync controller 440 may restrict a pre-fetching operation of the second accelerators such that the first accelerator occupies the memory. In some cases, among the consecutive operation instructions, when a previous operation instruction is performed by the first accelerator and an accelerator designated by the scheduler 420 is at least one of the second accelerators, the sync controller 440 may record, in the memory, an output of the first accelerator with respect to the memory such that the at least one second accelerator occupies the memory.

The second accelerator controller 450 may control the second accelerators to perform the second instructions when the second accelerators are designated by the scheduler 420.

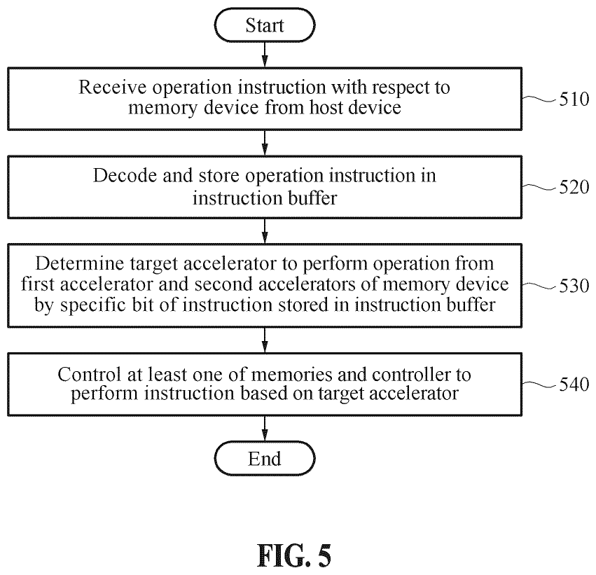

FIG. 5 is a flowchart illustrating an operating method of a memory device according to an embodiment. Operations described in FIG. 5 may be performed sequentially. However, embodiments are not limited thereto, and in some cases, the described operation may not necessarily be performed sequentially. For example, the order of the operations may change and/or at least two of the operations may be performed in parallel.

Referring to FIG. 5, a memory device in an embodiment may control at least one of the plurality of memories and a controller to perform an instruction through operations 510 to 540. Further details regarding each of operations 510 to 540 are described with reference to FIGS. 2-4.

In operation 510, the memory device may receive an operation instruction with respect to the memory device from a host device.

In operation 520, the memory device may decode and store the operation instruction received in operation 510 in an instruction buffer.

In operation 530, the memory device may determine a target accelerator to perform an operation from the first accelerator and the second accelerator of the memory device by the specific bit of the instruction stored in the instruction buffer in operation 520. The memory device may determine a target accelerator to perform an operation from the first accelerator and the second accelerator for each layer of the neural network model.

In operation 540, the memory device may control at least one memory of the plurality of memories and the controller to perform an instruction based on the target accelerator determined in operation 530. For example, when the target accelerator is the first accelerator, the memory device may control at least one of data movement in the first accelerator and execution of the processing unit in the first accelerator. In some examples, when the target accelerator is one of the second accelerators, the memory device may control at least one of an instruction fetch for the second accelerators and an operation mode of the second accelerators.

As used herein, an instruction fetch refers to the process of retrieving and decoding instructions that control the operation of the accelerator hardware. The instructions may be obtained from the software executing on the main processor or host system and are specific to the tasks assigned to the accelerator. In some cases, the accelerator retrieves the requested instructions from the memory or instruction cache. For example, an instruction fetch step may involve fetching the opcode and any associated operands required to execute the task.

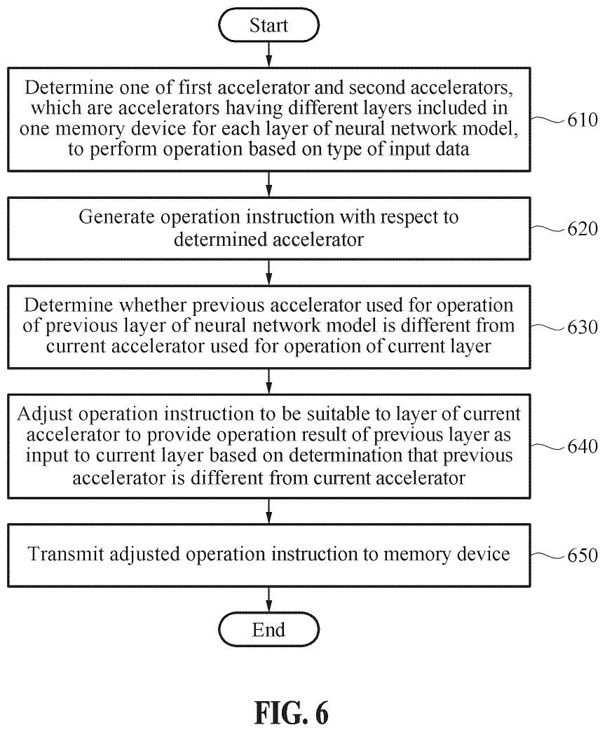

FIG. 6 is a flowchart illustrating an operating method of a host device according to an embodiment. Referring to FIG. 6, the host device in an embodiment may transmit an operation instruction to the memory device through operations 610 to 650. Details of each of the operations 610-650 have been provided with reference to FIGS. 2-4.

In operation 610, the host device may determine an accelerator to perform an operation from the first accelerator and the second accelerators. In some cases, each of the first and second accelerators have different layers included in a memory device corresponding to each layer of the neural network model based on a type of input data. For example, the host device may determine one of the first accelerator and the second accelerators to perform an operation depending on at least one of the size and dimension of the input data, a type of an operation performed by each layer of the neural network model, and batch processing of a layer performing the operation. Before performing operation 610, the host device may receive information including input data and an operation in the unit of operation block of an application program through an API.

In operation 620, the host device may generate an operation instruction with respect to the accelerator determined in operation 610.

In operation 630, the host device may determine whether a previous accelerator used for an operation of a previous layer of the neural network model is different from a current accelerator used for an operation of a current layer of the neural network model.

In operation 640, the host device may adjust the operation instruction generated in operation 620 to be suitable to a layer of the current accelerator such that an operation result of the previous layer is provided as an input to the current layer based on the determination that the previous accelerator is different from the current accelerator. The host device may adjust a setting bit value that controls an input and an output between different accelerators included in the operation instruction generated in operation 620 to be suitable to the layer of the current accelerator. In this case, adjusting the setting bit value to be suitable to the layer of the current accelerator may be construed as adjusting a setting bit value (e.g., a value of a specific bit of an instruction and/or a value of a sync bit) to be suitable to a type of an operation processed by the current accelerator.

Additionally, when the previous accelerator is the first accelerator and the current accelerator is at least one of the second accelerators, the host device may record an output of the first accelerator for an operation of the at least one second accelerator. When the previous accelerator is at least one of the second accelerators and the current accelerator is the first accelerator, the host device may record an output of the at least one second accelerator in the sync buffer such that the first accelerator is able to use an operation result of the second accelerator.

In operation 650, the host device may transmit the operation instruction adjusted in operation 640 to the memory device. The host device may be, for example, a CPU, a GPU, and/or a processor for a data center. However, the embodiments are not limited thereto.

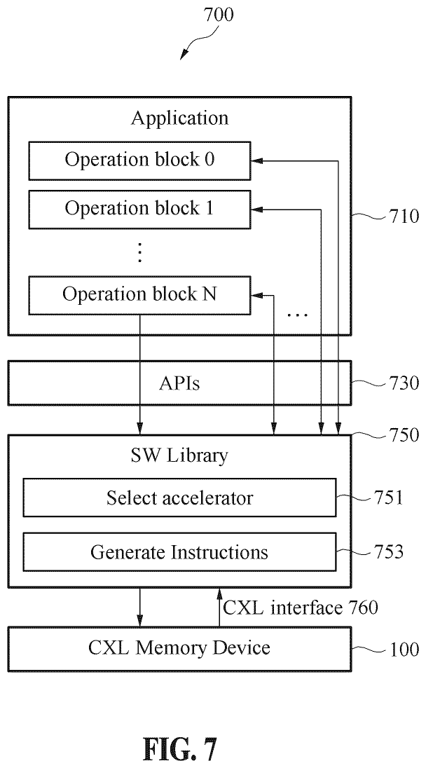

FIG. 7 illustrates an example of a structure in which a host device determines an accelerator for each operation according to an embodiment.

FIG. 7 illustrates a process in which the host device receives information including an operation and input data in the unit of operation blocks of an application program 710 through an API 730 and determines an accelerator of the memory device 100 for each operation.

The memory device 100 may be, for example, a CXL memory device using a CXL interface. However, the embodiments are not limited thereto.

The host device may receive information including an operation and input data in the unit of operation blocks of the application program 710 through the API 730 and may store the information in a software library 750 or a compiler of the host device. In some cases, the operation block may refer to a block including a plurality of operations and may be configured as the number of internal operations to minimize data movement between the memory device 100 and the host device.

The host device may select (or determine), using select accelerator 751, a PIM device or a PNM device in the memory device 100 to be an accelerator (or an operation device) using the information stored in the software library 750. When the accelerator is selected, the host device may generate instructions (753) suitable to the selected accelerator (among the first and second accelerators) and may transmit the instructions to the memory device 100 through a CXL interface 760. The transmitted instructions may be converted into instructions in an appropriate form through decoding in the memory device (as described in detail in FIGS. 2-4) and may be transmitted to each accelerator.

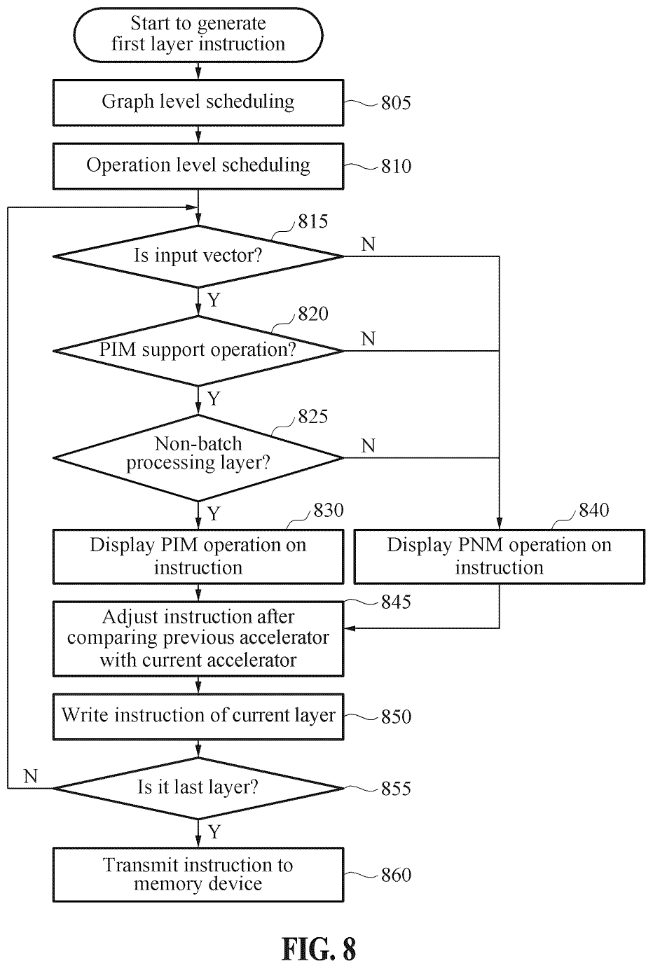

FIG. 8 is a flowchart illustrating a process of a host device to generate an instruction for an accelerator to perform a layer-wise operation of a neural network model according to an embodiment.

Referring to FIG. 8, the host device in an embodiment may transmit an instruction with respect to a memory device through operations 805 to 860.

In operation 805, for example, when an LLM is input in the form of a graph, the host device may perform graph-level scheduling by a graph scheduler. Large Language Models (LLMs) are sophisticated artificial intelligence models designed to understand and generate human-like text based on the input it receives. The models are trained on vast amounts of text data and can perform a variety of natural language processing tasks, including text generation, summarization, translation, and question-answering. In some cases, the input data or input representation provided to the LLM may be structured as a graph. For example, text data or linguistic relationships may be represented as a graph structure, where nodes represent words or phrases, and edges represent syntactic or semantic connections.

The graph scheduler may search graph information that is generated for training in advance for a core path of operation units driven in an operation device (e.g., a GPU (a main GPU), a first accelerator (a PNM device), a second accelerator (a PIM device)) or a mainly used accelerator and may store the found core path in an array configured as an index, which is an operation unit. In this case, for example, an index in the number format, such as 0, 1, and 2, may be sequentially stored in the graph information or an index of a previous operation and an index of a following operation are stored in a node, and an operation unit configured in at least one operation (e.g., add, sub, mul, convolution, Relu, etc.) may be connected to each index.

In some cases, the graph scheduler may generate an array for each operation device storing an index in the operation unit based on the graph information and the array information configured by an index in the operation unit. For example, the graph scheduler may generate an array for each operation device storing an index in the operation unit by considering the dependency between operations by a topological sorting method. In this case, the “topological sorting method” may be an algorithm for finding an order of a task and may refer to listing vertices without violating a preceding order of each vertex existing in a direction graph.

The graph scheduler may pair operation units to be executed at each stage to generate scheduling information in each operation device (e.g., a GPU, the first accelerator (a PNM device), and the second accelerator (a PIM device)) and may generate an array obtaining an operation unit pair to be performed at each stage. When driving a second operation device (e.g., the second accelerator (a PIM device) or a sub-GPU) contributes to a loss rather than performance improvement (with respect to data movement and copying among a plurality of different operation devices), the graph scheduler may change an index in the operation unit with respect to each operation device to be driven in a first operation device (e.g., the first accelerator (a PNM device) or a main-GPU) using a profiled performance metric, such as a pre-measured operation time and data transmission or copying delay.

According to an example, when the improvement in the performance is high according to internal data movement of different operation devices using the profiled performance metric, the graph scheduler may change an index in the operation unit with respect to an existing important path. By iteratively performing the search, an array in which index pairs are configured in an optimal order for driving an operation unit may be derived.

In operation 810, the host device may perform operation-level scheduling, such as which operation needs to be performed for each layer of a neural network model (e.g., an LLM). For each layer of the LLM, an accelerator that is advantageous for an operation acceleration of the layer among the first accelerator and the second accelerators of the memory device may exist. The host device may schedule an operation corresponding to the advantageous accelerator for each operation of a respective layer of the LLM. In this case, the host device may perform operation-level scheduling for selecting an optimal accelerator depending on a type of an operation by layer, the size and shape (a dimension) of input data, the size and shape (a dimension) of output data, and batch processing of an operation layer.

In operation 815, the host device may determine whether an input (input data) is a vector. When it is determined that the input is not a vector (i.e., ‘N’ in operation 815), operation 840 is performed. In operation 840, the host device may mark in a specific bit of an instruction that the instruction is an operation of the first accelerator (e.g., a PNM device).

When it is determined that the input is a vector (i.e., ‘Y’ in operation 815), the method proceeds to operation 820. In operation 820, the host device may determine whether an operation supported by the second accelerator (e.g., a PIM device) is performed on the input (e.g., a vector). When it is determined that the operation supported by the second accelerator (e.g., a PIM device) is not performed (i.e., ‘N’ in operation 820), the host device may mark a specific bit of an instruction such that the instruction is an operation of the first accelerator (e.g., a PNM device) in operation 840.

When it is determined that the operation supported by the second accelerator (e.g., a PIM device) is performed (i.e., ‘Y’ in operation 820), operation 825 is performed. In operation 825, the host device may determine whether the second accelerator (e.g., a PIM device) includes a non-batch processing layer. That is, in other words, whether the second accelerator (e.g., a PIM device) does not support a batch operation. When it is determined that the second accelerator (e.g., a PIM device) supports the batch operation (i.e., ‘N’ in operation 825), the host device may mark a specific bit of an instruction that the instruction is an operation of the first accelerator (e.g., a PNM device) in operation 840.

When it is determined that the second accelerator (e.g., a PIM device) does not support the batch operation (i.e., ‘Y’ in operation 825), the host device may mark a specific bit of an instruction that the instruction is an operation of the second accelerator (e.g., a PIM device) in operation 830.

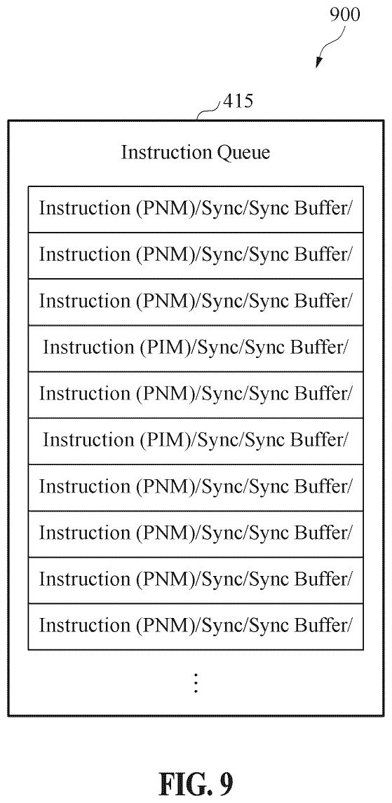

According to an embodiment, a specific bit of an instruction may display information about which of the first accelerator or the second accelerators performs the instruction. For example, when the specific bit is displayed as “1”, a corresponding instruction may refer to an instruction performed by the first accelerator. Additionally, when the specific bit is displayed as “0”, a corresponding instruction may refer to an instruction performed by the second accelerator(s). The instruction may be sequentially stored in the CXL buffer 310 described with reference to FIG. 3 and shown in the example of FIG. 9.

In operation 845, the host device may adjust an instruction after comparing a previous accelerator used for an operation of a previous layer with a current accelerator used for an operation of a current layer. In this case, the current accelerator may correspond to an accelerator indicated in operation 830 or 840. When an instruction for the operation of the previous layer is different from an instruction for the operation of the current layer, each operation may be performed by different accelerators. In this case, the host device may control inputs and outputs between different accelerators and may provide an operation result of one accelerator as an input to the other accelerator. For example, for an operation of a current second accelerator, the host device may record an output of a previous first accelerator in an input area of the second accelerator. Additionally or alternatively, for an operation of a current first accelerator, the host device may adjust an instruction to record an output of a previous second accelerator in a sync buffer or a buffer area of the first accelerator.

In operation 850, the host device may record the instruction adjusted in operation 845 with respect to the current layer. The host device may, for example, record the instruction of the current layer in an instruction memory or a buffer.

In operation 855, the host device may determine whether the current layer is the last layer. When it is determined that the current layer is not the last layer in operation 855 (operation 855: N), the host device may determine whether an input of a new layer is a vector by operation 815.

When it is determined that the current layer is the last layer in operation 855 (operation 855: Y), the host device may transmit the instruction to the memory device. For example, when the memory device uses a CXL interface, the host device may write the instruction in a memory space mapped with CXL.io (as described with reference to FIG. 2).

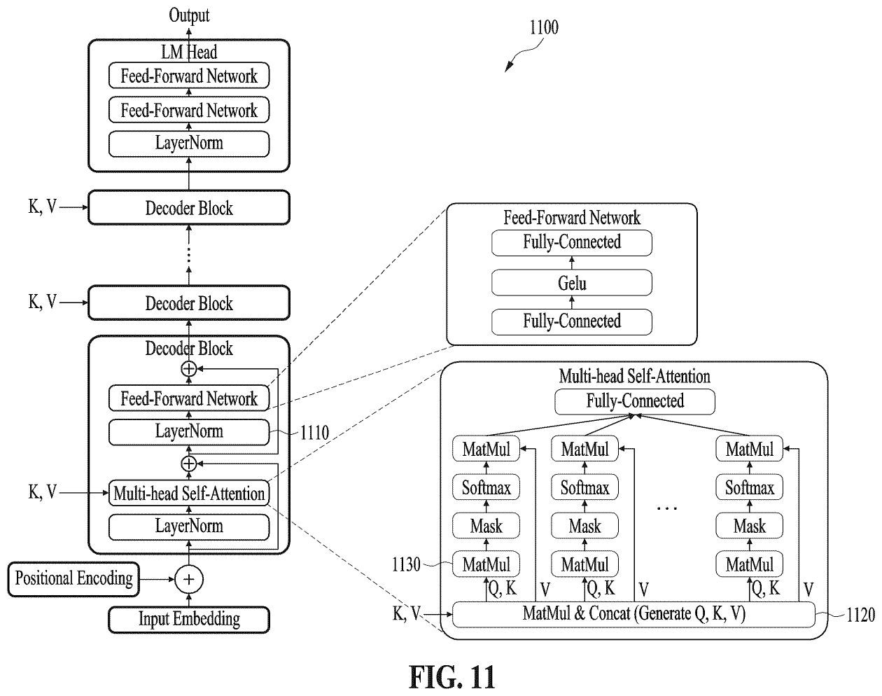

FIG. 9 illustrates an example in which instructions are stored in a buffer in a memory device according to an embodiment. FIG. 9 illustrates a state in which instructions generated by a decoder are sequentially stored in the instruction queue 415 of a memory device. In some cases, instructions for an accelerator of a layer that is advantageous to acceleration according to each layer of the neural network model may be sequentially stored in the instruction queue 415. Details regarding the neural network model are provided with reference to FIG. 11.

According to an embodiment, the acceleration performance may be improved by increasing utilization of the accelerator through effective data movement between the first accelerator and the second accelerators since both the first accelerator (e.g., a PNM device) and the second accelerators (e.g., a PIM device) exist in a memory device.

In some cases, each instruction stored in the instruction queue 415 may include information about which of the first accelerator (e.g., a PNM device) and the second accelerators (e.g., a PIM device) the instruction is for, the use of a sync bit and a sync buffer, and information on the sync buffer. For example, the sync bit may be set to be “1” when a synchronization operation between accelerators needs to be performed because among consecutive operation instructions, an operation for a previous layer and an operation for a current layer are performed by accelerators of different layers. The sync buffer may store an operation result of an interoperation between the first accelerator and the second accelerator. For example, an operation result (e.g., an operation result of the processing unit 460 of the first accelerator and/or an operation result of the processing unit 470 of the second accelerator) performed by an instruction transmitted to each accelerator from the sync controller may be stored in the sync buffer.

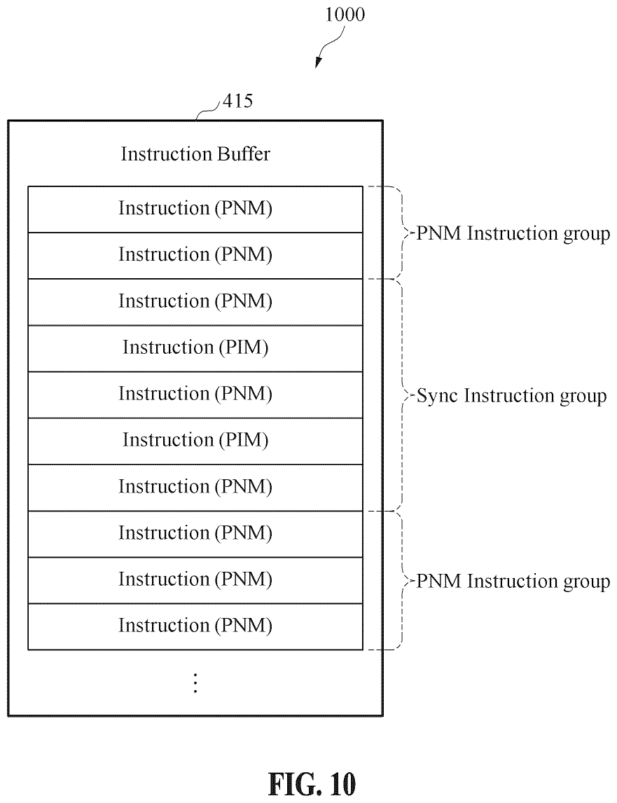

FIG. 10 illustrates an example in which an instruction group based on an accelerator is stored in a buffer of a memory device according to an embodiment. FIG. 10 illustrates a state in which instructions generated by a decoder are sequentially grouped as an instruction group for each accelerator or controller and stored in the instruction queue 415.

Referring to FIG. 10, for the instruction group, an instruction group for a first accelerator controller of a first accelerator and an instruction group for a sync controller may be sequentially stored.

The memory device may identify a target accelerator by viewing a specific bit of instructions stored in an instruction buffer and may designate an instruction group based on a position of a layer in which a type of an accelerator changes.

For example, when an instruction group to be processed by the memory device uses an accelerator of one of an upper layer or a lower layer, a scheduler of the memory device may transmit a corresponding instruction to the first accelerator controller or the second accelerator controller. In some cases, when the instruction group to be processed uses both an accelerator of the upper layer and an accelerator of the lower layer, the scheduler of the memory device may transmit a corresponding instruction to the sync controller. The sync controller may read two instructions included in a group of the instructions stored in the instruction queue 415, may identify a type and order of an operation corresponding to the read instructions, and may search for a matching sync operation or a matching sync action in a lookup table (LUT) stored in the sync controller. The sync controller may adjust a first instruction with respect to the first accelerator and a second instruction with respect to the second accelerator using the matched sync operation or sync action. The sync controller may transmit adjusted instructions to corresponding accelerators, respectively, and may store and/or load data in or from a buffer (e.g., the sync buffer) for the interoperation between the first accelerator and the second accelerator.

For example, the sync controller may record an operation result of the first accelerator in a memory (e.g., DRAM) in parallel with an operation in the unit that the second accelerator is able to compute once. In some examples, in case the second accelerator is capable of processing 10 units of operations at once, the result of the operation performed by the first accelerator is divided into chunks corresponding to the amount the second accelerator can handle at once (e.g., 10 units of operation) and recorded in parallel in memory.

According to an embodiment, instruction groups are stored in the instruction queue 415 of the memory device. However, a compiler in the software of the host device may group and transmit instructions for accelerators of the memory device or may transmit in the form of instructions by displaying group identification information (e.g., a group ID) on a specific bit designated to instruction set architecture (ISA).

FIG. 11 illustrates an example of a method of a host device to determine an accelerator to perform a layer-wise operation of a neural network model according to an embodiment. Referring to FIG. 11, a configuration of a neural network model 1100 in one embodiment is illustrated.

The neural network model 1100 may be, for example, a GPT model that is a type of LLM. However, the example is not limited thereto and the neural network model 1100 may be applied to various other LLMs.

The neural network model 1100 may include a plurality of linear operation layers, such as a matrix multiplication layer and a fully-connected layer, and a plurality of non-linear operation layers, such as a softmax layer, a layer normalization layer, and a Gaussian error linear unit (GELU).

In some cases, the first accelerator (e.g., a PNM device) may design an operator (e.g., to meet the demand or bandwidth), but since the first accelerator is disposed outside of a memory die, a bandwidth for transmitting data from memories to the first accelerator may be lower than the second accelerator. Accordingly, the first accelerator may have low acceleration performance because the first accelerator takes a longer time to load a large volume of an input matrix or a weight matrix than the second accelerator. However, since the first accelerator is disposed outside the memory die, the first accelerator may perform a non-linear operation that the second accelerator is not able to support due to limitations in an area or a DRAM process.

In addition, since the second accelerator (e.g., a PIM device) is disposed next to a memory bank array in the memory die, the second accelerator may be able to accelerate a linear operation having low complexity. The second accelerator may be able to perform the acceleration of a matrix and vector multiplication operation (e.g., matrix X vector operation) among matrix multiplications since the second accelerator stores a matrix in the memory bank array and has an appropriate form to perform an operation on an input vector.

The host device may accelerate an operation by selecting or determining an accelerator that may perform an (i.e., or is advantageous to) operation acceleration for each layer of the neural network model 1100 in the memory device. The host device may determine whether an accelerator responsible for an operation for each layer is the first accelerator or the second accelerator depending on a type of an input to each layer of the neural network model 1100.

The host device may, for example, instruct the first accelerator to perform a LayerNorm operation 1110 in the first layer of the neural network model 1100, and then, may instruct the second accelerator to perform a MatMul operation 1120 in the next layer. The MatMul operation 1120 may be an operation of generating a Q matrix. The host device may perform a MatMul operation 1130 between the Q matrix and a K matrix using a MatMul operation result in a third layer of the neural network model 1100. The MatMul operation 1130 between the Q matrix and the K matrix may be performed by the first accelerator.

For example, the host device may determine an accelerator responsible for an operation for each layer through software, such as a compiler or a library, and may generate an instruction for the determined accelerator. In this case, the generated instruction may include information on an accelerator performing a corresponding operation for each layer that may be recorded depending on a dimension of input data.

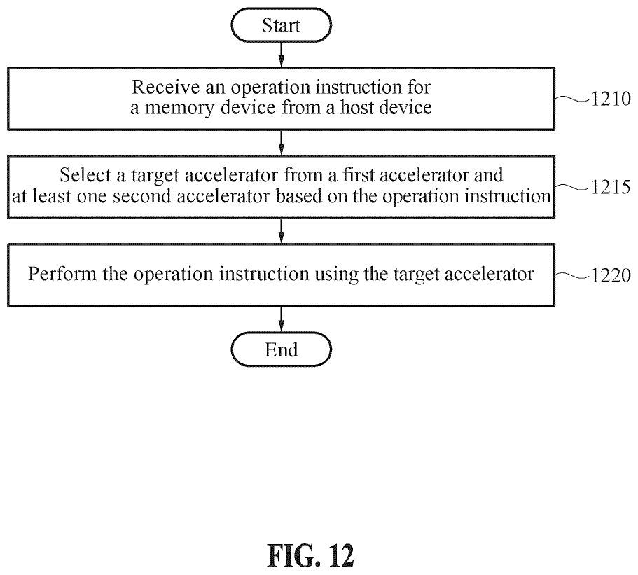

FIG. 12 is a flowchart illustrating an operating method of a memory device according to an embodiment. Operations described in FIG. 12 may be performed sequentially. However, embodiments are not limited thereto, and in some cases, the described operation may not necessarily be performed sequentially.

Referring to FIG. 12, a memory device in an embodiment may control at least one of the plurality of memories and a controller to perform an instruction through operations 1210 to 1220. Further details regarding each of operations 1210 to 1220 are described with reference to FIGS. 2-4.

In operation 1210, the memory device may receive an operation from a host device.

In operation 1215, the memory device may select a target accelerator to perform the operation instruction from among the first accelerator and the second accelerator of the memory device. In some cases, the selection of the target accelerator may be based on the specific bit of the instruction stored in the instruction buffer. The memory device may determine a target accelerator to perform the operation instruction for each layer of the neural network model.

In operation 1220, the memory device may control a controller to perform the operation instruction based on the target accelerator determined in operation 1215. For example, when the target accelerator is the first accelerator, the memory device may control at least one of data movement in the first accelerator and execution of the processing unit in the first accelerator. In some examples, when the target accelerator is the second accelerator, the memory device may control at least one of an instruction fetch for the second accelerators and an operation mode of the second accelerators.

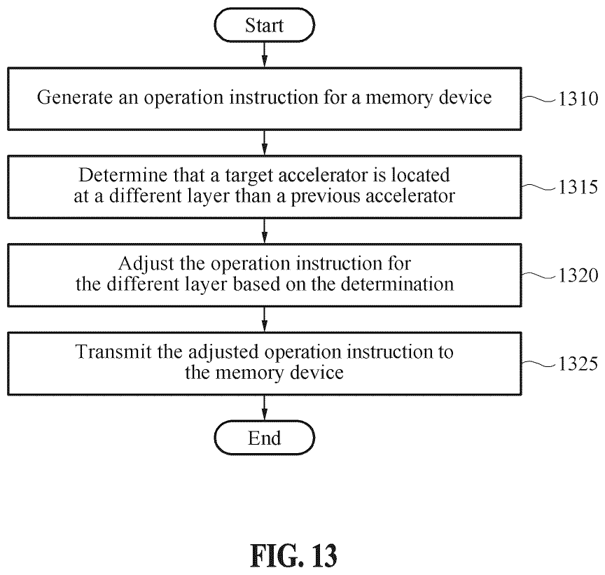

FIG. 13 is a flowchart illustrating an operating method of a memory device according to an embodiment. Operations described in FIG. 13 may be performed sequentially. However, embodiments are not limited thereto, and in some cases, the described operation may not necessarily be performed sequentially.

Referring to FIG. 13, a memory device in an embodiment may control at least one of the plurality of memories and a controller to perform an instruction through operations 1310 to 1325. Further details regarding each of operations 1310 to 1325 are described with reference to FIGS. 2-4 and 6.

In operation 1310, the host device may generate an operation instruction for a memory device. For example, the generated operation instruction may include an instruction for the first accelerator and/or an instruction for the second accelerator.

In operation 1315, the host device may determine that a target accelerator for processing the operation instruction is located at a different layer of the memory device than a previous accelerator used for processing a previous operation instruction. In some cases, each of the first and second accelerators have different layers included in a memory device corresponding to each layer of the neural network model based on a type of input data. According to an embodiment, the host device may determine whether a previous accelerator used for an operation of a previous layer of the neural network model is different from a current accelerator used for an operation of a current layer of the neural network model.

In operation 1320, the host device may adjust the operation instruction for the different layers based on the determination of operation 1315. In some cases, the adjustment is made to be suitable to a layer of the current accelerator such that an operation result of the previous layer is provided as an input to the current layer based on the determination that the previous accelerator is different from the current accelerator.

In operation 1325, the host device may transmit the operation instruction adjusted in operation 1320 to the memory device. The host device may be, for example, a CPU, a GPU, and/or a processor for a data center. However, the embodiments are not limited thereto.

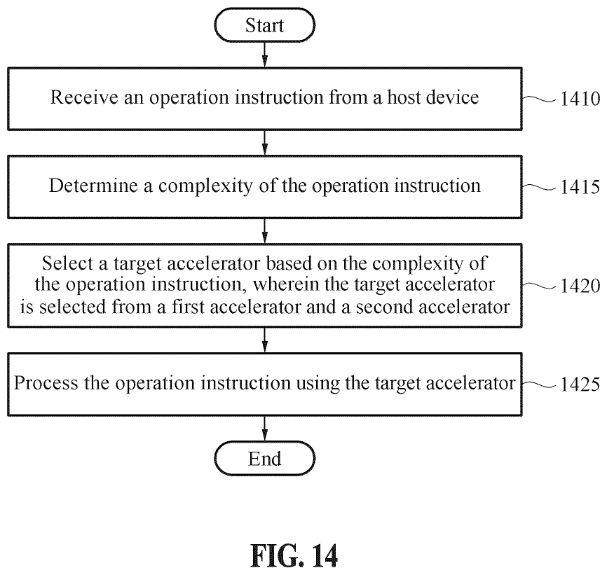

FIG. 14 is a flowchart illustrating an operating method of a memory system according to an embodiment. Operations described in FIG. 14 may be performed sequentially. However, embodiments are not limited thereto, and in some cases, the described operation may not necessarily be performed sequentially. Further details regarding each of operations 1310 to 1325 are described with reference to FIGS. 1-4.

In operation 1410, the memory device may receive an operation instruction with respect to the memory device from a host device.

In operation 1415, the memory device may determine a complexity of the operation instruction. For example, the first accelerator may process a complex operation, such as a matrix linear operation between matrices and a non-linear operation. The second accelerator may process a relatively simple operation, such as a linear operation between a matrix and a vector.

In operation 1420, the memory device may select a target accelerator based on the complexity of the operation instruction, wherein the target accelerator is selected from a set including a first accelerator disposed outside a memory of the memory device and at least one second accelerator disposed within the memory device. In some examples, the first accelerator may be selected as a target accelerator to process a high complexity operation and the second accelerator may be selected as a target accelerator to process a low complexity operation.

In operation 1425, the memory device may process the operation instruction using the selected target accelerator.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. The disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

Accordingly, other implementations are within the scope of the following claims.

What is claimed is:

1. A memory device comprising:
a first accelerator disposed outside a memory and configured to perform a first operation based on a first instruction received from a host device; and
at least one second accelerator disposed within the memory and configured to perform a second operation different from the first operation using a corresponding memory bank of the memory based on a second instruction received from the host device.

2. The memory device of claim 1, wherein the first accelerator comprises a plurality of acceleration engines configured to accelerate at least one operation performed by the memory device, and
wherein each of the plurality of acceleration engines comprises a control unit configured to generate instructions and a processing unit configured to process the generated instructions.

3. The memory device of claim 2, wherein the control unit comprises:
a decoder configured to decode instructions from the host device, wherein the first operation and second operation are performed based on the decoding.

4. The memory device of claim 2, wherein the control unit comprises:
a scheduler configured to select an accelerator from a set including a first accelerator controller corresponding to the first accelerator, a second accelerator controller corresponding to the at least one second accelerator, and a sync controller.

5. The memory device of claim 4, wherein the sync controller is selected based on a sync bit indicating whether consecutive instructions are performed by different accelerators.

6. The memory device of claim 4, wherein the sync controller is configured to store an operation result of the at least one second accelerator and limit a pre-fetching operation of the at least one second accelerator.

7. The memory device claim 4, wherein the sync controller is configured to record an output of the first accelerator and provide the output to the at least one second accelerator. 8 The memory device of claim 2, wherein each of the plurality of acceleration engines further comprises a data buffer configured to store an operation result, wherein the processing unit is configured to perform operations based on the stored operation result.

9. The memory device of claim 1, wherein the first accelerator comprises a processing near memory (PNM) device, and
the at least one second accelerator comprises a processing in memory (PIM) device.

10. The memory device of claim 1, wherein the first operation comprises a non-linear operation or a multiplication operation between matrices, and
the second operation comprises a linear operation or a multiplication operation between a matrix and a vector.

11. A method of operating a memory device, the method comprising:
receiving an operation instruction for a memory device from a host device;
selecting a target accelerator from a set including a first accelerator disposed outside a memory of the memory device and at least one second accelerator of the memory device disposed within the memory based on the operation instruction; and
performing the operation instruction using the target accelerator.

12. The method of claim 11, further comprising decoding the operation instruction, wherein the target accelerator is selected based on the decoded operation instruction.

13. The method of claim 11, wherein selecting the target accelerator comprises selecting from among a plurality of second accelerators corresponding to a plurality of bank groups of the memory, respectively.

14. A method comprising:
generating an operation instruction for a memory device;
determining that a target accelerator for processing the operation instruction is located at a different layer of the memory device than a previous accelerator used for processing a previous operation instruction;
adjusting the operation instruction for the different layer based on the determination; and
transmitting the adjusted operation instruction to the memory device.

15. The method of claim 14, wherein the determining comprises:
identifying instruction information for the operation instruction including at least one of a size and a dimension of input data, an operation type of a layer of a neural network model, and batch processing information, wherein the determination is based on the instruction information.

16. The method of claim 14, wherein the adjusting of the operation instruction comprises:
adjusting a bit value of the operation instruction for controlling an input and an output between different.

17. The method of claim 14, further comprising:
recording an output of the previous accelerator in a memory of the target accelerator.

18. The method of claim 14, further comprising:
receiving input data and operation block information, wherein the operation instruction is generated based on the input data and the operation block information.

19. A non-transitory computer-readable storage medium storing instructions that, when executed by a processor, cause the processor to perform the method of claim 11.

20. A non-transitory computer-readable storage medium storing instructions that, when executed by a processor, cause the processor to perform the method of claim 14.

21. A method comprising:
receiving, at a memory device, an operation instruction from a host device;
determining a complexity of the operation instruction;
selecting a target accelerator based on the complexity of the operation instruction, wherein the target accelerator is selected from a set including a first accelerator disposed outside a memory of the memory device and at least one second accelerator disposed within the memory device; and
processing the operation instruction using the target accelerator.

22. The method of claim 21, wherein the complexity is determined based on whether an operation of the operation instruction is linear.

23. The method of claim 21, wherein the complexity is determined based on whether an operation of the operation instruction includes multiplication of two matrices.
